(19) United States
(12) Patent Application Publication
(10) Pub. No.: US 2020/0034860 A1
(43) Pub. Date: Jan. 30, 2020

(54) SUPPLY CHAIN INVENTORY MANAGEMENT AND INFORMATION SHARING SYSTEM

(71) Applicant: Chris B. Willis, Edmond, OK (US)

(72) Inventor: Chris B. Willis, Edmond, OK (US)

(21) Appl. No.: 16/046,305

(22) Filed: Jul. 26, 2018

(51) Int. Cl. G06Q 30/02; G06Q 10/08; G06K 7/10

(52) U.S. Cl. CPC G06Q 30/0206; G06K 7/10475; G06Q 10/087

(57) ABSTRACT

A supply chain inventory management and information sharing system comprises a plurality of tag readers and a computer server. The tag readers are configured to read a tag of an item of inventory of members of a supply chain. The computer server includes a processing element in electronic communication with a memory element with the processing element being configured to receive data from the tag readers regarding items of inventory, receive data regarding an organizational profile of each member's efficiency contribution utilization of the supply chain, receive financial data from each member of the supply chain for formulating the company's overall health, host a website that provides access to inventory data, organizational data, and financial data, segment data to allow users to view selected portions of the inventory data, and organizational data, and utilize the financial data to calculate selected activity ratios, liquidity ratios, solvency ratios, or profitability ratios.

### BACKGROUND OF THE INVENTION

### Field of the Invention

Embodiments of the current invention relate to computer-based systems for managing inventory and sharing information across a supply chain.

### Description of the Related Art

A supply chain is a collection of organizations, people, activities, information, and resources involved in moving a product or service from supplier to customer. In the construction industry, the supply chain may include raw material (wood, stone, brick, metal, glass, etc.) suppliers, manufacturers, distributers, wholesalers, contractors, laborers, and the like. All of these members are involved, in one way or another, in any given building project. However, typically, the project data each member has, such as inventory data and personnel data, is not easily accessible to the other members. This lack of information sharing leads to increased costs and delays in finishing building projects.

### SUMMARY OF THE INVENTION

Embodiments of the current invention solve the above-mentioned problems and provide a distinct advance in the art of managing inventory and sharing information across a supply chain by allowing members to share information through a centralized system. An embodiment of the current invention provides a supply chain inventory management and information sharing system comprising a plurality of tag readers and a computer server. The tag readers are configured to read a tag of an inventory item of members of a supply chain. The computer server includes a processing element configured to receive data from the tag readers regarding inventory items, receive data regarding an organizational profile of each member of the supply chain, receive financial data from each member of the supply chain, host a website that provides access to inventory data, organizational data, and financial data, segment data to allow users to view selected portions of the inventory data, and organizational data, and utilize the financial data to calculate the following, but not limited to, selected activity ratios, liquidity ratios, solvency ratios, or profitability ratios.

Another embodiment of the current invention provides a supply chain inventory management and information sharing system comprising a plurality of tag readers and a computer server. The tag readers are configured to read a tag of an inventory item of members of a supply chain. The computer server includes a processing element configured to receiving data from the tag readers regarding inventory items, receive data regarding an organizational profile of each member of the supply chain, receive financial data from each member of the supply chain, receive data regarding a plurality of construction projects, host a website that provides access to inventory data, organizational data, and financial data, the website including a login page configured to accept data from the user used to provide access to the website, a home page including features to which every user has access, a company page including information about each member of the supply chain, a profile page including personalized marketing, communication, sales, and industry connections of products and services, a toolbar including a plurality of interactive components, which, when activated, offer additional information or perform one or more functions, provide video conferencing service that allows individuals of members of the supply chain to have a virtual meeting, send a notification to an individual who was scheduled to attend the virtual meeting but did not or need additional input or assistance from non-planned participant(s) in meeting, provide asset resale management such that an item that has been in a member's possession for a threshold period of time is marketed for sale on the website, determine a period of time for when unused inventory or stock materials are listed for sale, segment data to allow users to view selected portions of the inventory data, and organizational data, and utilize the financial data to calculate a wide-range performance operations management data reference points including, but not limited to activity ratios, liquidity ratios, solvency ratios, profitability ratios, fixed cost coverage ratios, variable cost coverage ratios, etc.

Yet another embodiment of the current invention provides a supply chain inventory management and information sharing system comprising a plurality of tag readers and a computer server. The tag readers are configured to read a tag of an inventory item of members of a supply chain. The computer server includes a processing element configured to receiving data from the tag readers regarding inventory items, receive data regarding an organizational profile of each member of the supply chain, receive financial data from each member of the supply chain, receive data regarding a plurality of construction projects, host a website that provides access to inventory data, organizational data, and financial data, the website including a login page configured to accept data from the user used to provide access to the website and scope of authorization based upon title position, a home page including features to which every user has access, a company page including information about each member of the supply chain, a profile page including personalized marketing, communication, sales, and industry connections of products and services, a toolbar including a plurality of interactive components, which, when activated, offer additional information or perform one or more functions, provide video conferencing service that allows individuals of members of the supply chain to have a virtual meeting, send a notification to an individual who was scheduled to attend the virtual meeting but did not or request additional specialized knowledge or further assistance from external party(s) outside of the meeting, provide asset resale management such that an item that has been in a member's possession for a threshold period of time is marketed for sale on the website via automation or traditional listing procedures, determine a period of time for when unused inventory or stock materials are listed for sale, segment data to allow users to view selected portions of the inventory data, and organizational data, and utilize the financial data to calculate performance equations expressed, but not limited to the following, covering the overall financial ratios relating to the standard business operations analysis automation equations for a company's overall business operations: selected activity ratios, liquidity ratios, solvency ratios, or profitability ratios, wherein the activity ratios include inventory turnover, receivable turnover, payables turnover, and asset turnover, the liquidity ratios element include current ratio, quick ratio, and cash ratio, the solvency ratios include debt-to-asset, debt-to-capital, debt-to-equity, and interest coverage, and the profitability ratios include gross profit margin, operating profit margin, net profit margin, return on asset, return on equity, purchases, total debt, and earnings before interest and taxes, fixed cost and variable cost coverage ratios.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of an inventory management and information sharing system, constructed in accordance with various embodiments of the current invention, for use by members of a supply chain;

FIG. 2 is a schematic block diagram illustrating various electronic components of a computer server, which, itself, is a component of the inventory management and information sharing system;

FIG. 3 is a block diagram illustrating various components of a website that is hosted on the computer server;

FIG. 4 is a block diagram illustrating various components of a login page of the website;

FIG. 5 is a block diagram illustrating various components of a home page of the website;

FIG. 6 is a block diagram illustrating various components of a company page of the website;

FIG. 7 is a block diagram illustrating various components of a profile page of the website;

FIG. 8 is a block diagram illustrating various components of a toolbar of the website;

FIG. 9 is a first list of choices for segmenting data related to the supply chain;

FIG. 10 is a second list of choices for segmenting data related to the supply chain;

FIG. 11 is a third list of choices for segmenting data related to the supply chain;

FIG. 12 is a fourth list of choices for segmenting data related to the supply chain;

FIG. 13 is a box for providing a search string to segment data related to the supply chain;

FIG. 14 is a fifth list of choices for segmenting data related to the supply chain;

FIG. 15 is a sixth list of choices for segmenting data related to the supply chain;

FIG. 16 is a seventh list of choices for segmenting data related to the supply chain;

FIG. 17 is a eighth list of choices for segmenting data related to the supply chain;

FIG. 18 is a ninth list of choices for segmenting data related to the supply chain; and

FIG. 19 is a tenth list of choices for segmenting data related to the supply chain.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

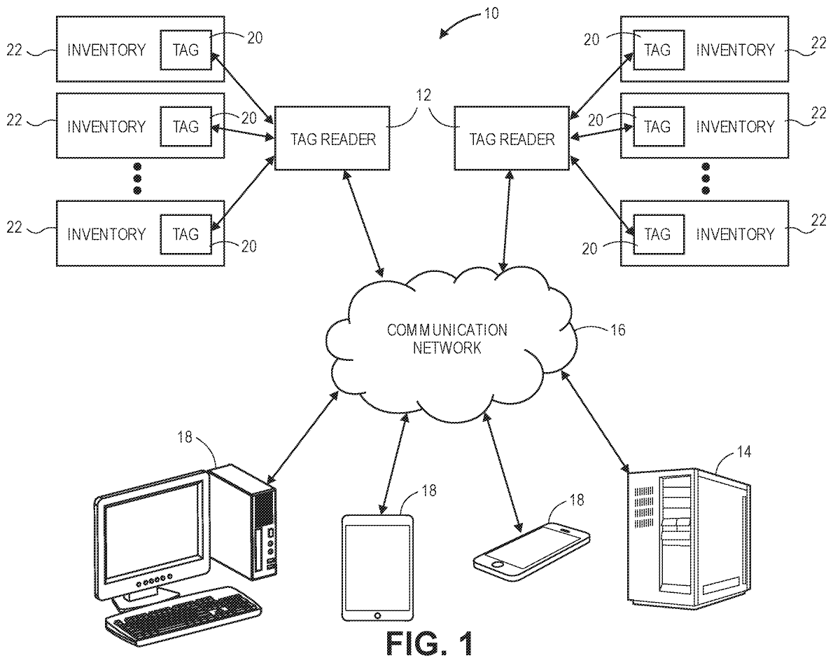

An inventory management and information sharing system 10, constructed in accordance with various embodiments of the current invention, is shown in FIG. 1 and may broadly comprise a plurality of tag readers 12 and one or more computer servers 14. The system 10 interfaces with a communication network 16 to allow the components of the system 10 to communicate with one another. The communication network 16 further allows the system 10 to communicate with a plurality of electronic devices 18, each of which can retrieve data from, store data to, or modify data on the computer server 14. The system 10 is generally utilized for inventory management and information sharing among members of a supply chain for an industry, such as the construction industry. The members (also known as “Partners”) may include raw material suppliers, manufacturers, distributors, contractors, laborers, and so forth. The members may also be corporations, companies, partnerships, etc.

The communication network 16 may include the Internet, cellular communication networks, local area networks, metro area networks, wide area networks, cloud networks, plain old telephone service (POTS) networks, and the like, or combinations thereof. The communication network 16 may be wired, wireless, or combinations thereof and may include components such as modems, gateways, switches, routers, hubs, access points, repeaters, towers, and the like. The electronic devices 18 may connect to the communication network 16 either through wires, such as electrical cables or fiber optic cables, or wirelessly, such as radio frequency (RF) communication using wireless standards such as cellular 2G, 3G, 4G, LTE, or 5G, Institute of Electrical and Electronics Engineers (IEEE) 802.11 standards such as WiFi, IEEE 802.16 standards such as WiMAX, Bluetooth™, or combinations thereof.

Each electronic device 18 may be embodied by a workstation computer, a desktop computer, a laptop computer, a palmtop computer, a notebook computer, a tablet or a tablet computer, a smartphone, a smart watch, a personal digital assistant (PDA), or the like. The electronic device 18 may include components such as processors, memory, a display, a touch screen or a keyboard, speakers, cameras, microphones, and the like, which will not be discussed in detail. The electronic device 18 may include, or have access to, software programs or applications such as web browsers, video conferencing software, email software, text messaging software, database software, and so forth. The electronic device 18 executes the software programs or applications in order to download and view web pages or data from the computer server 14, upload data to the computer server 14, transmit and receive video conferencing signals, transmit and receive email, transmit and receive text messages, etc.

Each tag reader 12 generally receives data from a tag 20 positioned in or on a piece of inventory 22. The tag 20 may be a radio frequency identification (RFID) tag, a bar code, a quick response (QR) code, or the like, or combinations thereof, and typically includes a unique number or other data that identifies the inventory object to which it is attached. The inventory 22 may include any item or object, such as equipment and materials, that a member of the supply chain who uses the system 10 would like to track. The tag reader 12 may include RFID readers, bar code readers, QR readers, or the like or combinations thereof. It is possible that one or more electronic devices 18 could incorporate one tag reader 12 such that the electronic device 18 is able to read the tags 20 of the inventory 22. The tag reader 12 transmits data regarding the items of inventory through the communication network 16 to the computer server 14.

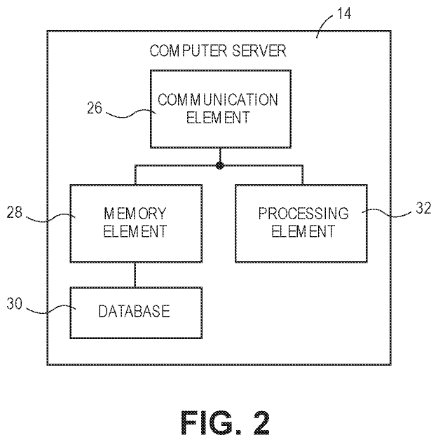

The computer server 14 generally hosts one or more websites 24, allows users to store and retrieve data, provides video conferencing, performs computations, and so forth. The computer server 14 includes a communication element 26, a memory element 28, a database 30, and a processing element 32, as shown in FIG. 2. Furthermore, the computer server 14 may include a plurality of server machines, virtual servers, or combinations thereof which are located in one or more geographic locations.

The communication element 26 generally allows the computer server 14 to communicate with the communication network 16, although the communication element 26 may also allow the computer server 14 to communicate with electronic devices 18 and other computer servers 14. The communication element 26 may include signal and/or data transmitting and receiving circuits, such as antennas, amplifiers, filters, mixers, oscillators, digital signal processors (DSPs), and the like. The communication element 26 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE) or 5G, Institute of Electrical and Electronics Engineers (IEEE) 802.11 standard such as WiFi, IEEE 802.16 standard such as WiMAX, Bluetooth™, or combinations thereof. In addition, the communication element 26 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 26 may establish communication through connectors or couplers that receive metal conductor wires or cables which are compatible with networking technologies such as ethernet. In certain embodiments, the communication element 26 may also couple with optical fiber cables. The communication element 26 may be in electronic communication with the memory element 28 and the processing element 32.

The memory element 28 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 28 may be embedded in, or packaged in the same package as, the processing element 32. The memory element 28 may include, or may constitute, a “computer-readable medium”. The memory element 28 may store the instructions, code, code statements, code segments, software, firmware, programs, applications, apps, services, daemons, or the like that are executed by the processing element 32. The memory element 28 may also store settings, data, documents, sound files, photographs, movies, images, databases, and the like.

The database 30 is a collection of information that is organized so that it can be easily accessed, managed and updated. The database 30 may include, or be embodied by, relational databases, distributed databases, cloud databases, or combinations thereof. The information stored in the database 30 may include data related to inventory, such as an item number or code, an item type, an item description, an item location, an item owner, an entry date, and so forth, from members across the supply chain. The database 30 may be a component of the memory element 28 or may be in communication with the memory element 28.

The processing element 32 may comprise one or more processors. The processing element 32 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 32 may generally execute, process, or run instructions, code, code segments, code statements, software, firmware, programs, applications, apps, processes, services, daemons, or the like. The processing element 32 may also include hardware components such as registers, finite-state machines, sequential and combinational logic, and other electronic circuits that can perform the functions necessary for the operation of the current invention. In certain embodiments, the processing element 32 may include multiple computational components and functional blocks that are packaged separately but function as a single unit. The processing element 32 may be in electronic communication with the other electronic components through serial or parallel links that include universal busses, address busses, data busses, control lines, and the like.

Through the use of hardware, software, firmware, or combinations thereof, the processing element 32 executes, processes, or runs server-related applications or software such as website hosting, webpage service, database storage, video conference service, text message service, paging service, computation and calculation service, and so forth in order to provide the server 14 and the system 10 with the features discussed hereinafter.

The server 14 and the processing element 32 receive data from the tag readers 12 regarding the inventory from one or more members. The data from the tag readers 12 may include an item number or code, a geolocation, a timestamp (time of day and date), and so forth. The data may be stored in the database 30. Users (employees of members of the supply chain) may utilize electronic devices 18 to also transmit data to the server 14 regarding the inventory 22, such as item types, cost or value of the item, description, ownership, and the like. Users further utilize electronic devices 18 to transmit data to the server 14 regarding construction projects, such as start dates, milestone dates, projected end dates, participating members, roles of each member, individuals involved from each member, inventory (equipment and supplies) used, projected budgets, and so forth. The data is stored in the database 30. Users may also may utilize electronic devices 18 to transmit data to the server 14 regarding an organizational profile of each member of the supply chain. The organizational data may formulate the company's overall health (i.e. ranging from the efficient use of capital, capital assets, supply and reverse supply chain resources). Thus, the database 30 may also include data regarding each member, such as an organization name, an organization type, a geolocation, a number of employees, and so forth. The database 30 may further include financial information about each member. For example, each member may enter sales information, cost information, expenditure information, etc. into the database 30.

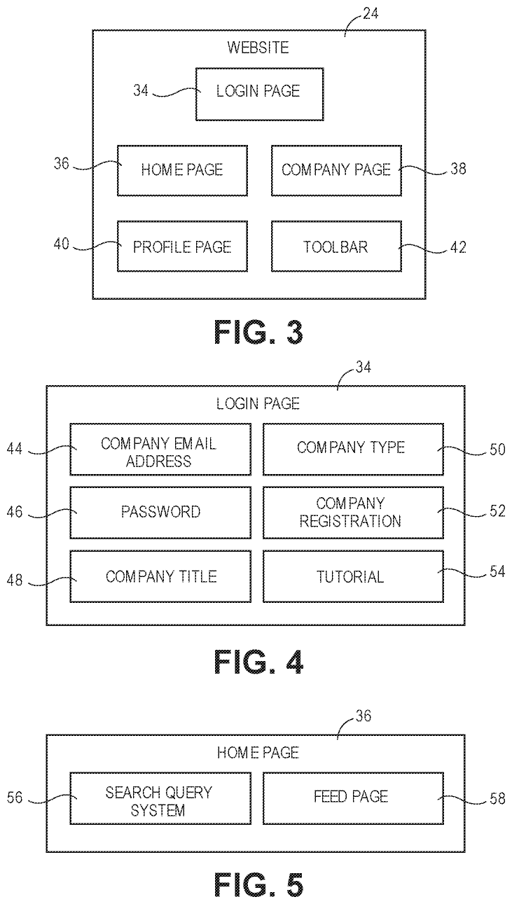

The server 14 also provides, or serves, the website 24 to which users can log in. The website 24 may be in communication with the database 30 and, thus, allows users to store data in, and/or retrieve data from, the database 30. The website 24 includes a login page 34, a home page 36, a company page 38, a profile page 40, and a toolbar 42, as shown in FIG. 3.

The login page 34, as shown in FIG. 4, includes the following data entry fields: company email address 44, password 46, company title 48, company type 50, and company registration 52, each of which is configured to accept data from the user used to provide access to the website 24. The company email address 44 may provide validation and streamline updates and search queries to email. The password 46 individualizes the setting and controls access and settings. The company title 48 validates the person's authorization authority and strategic target marketing. The company type 50 may include: Manufacturer, Supplier, Contractor, and may provide further segmentation, tracking and controls of the supply chain, and strategic marketing. The company registration 52 provides a platform sign-up for company and users. The login page 34 further includes a tutorial 54 which is a video demonstration of how the system 10 works and the value proposition.

The home page 36, as shown in FIG. 5, includes features to which every user has access to their own data contribution performance which then is factored towards the company's overall health by compiling all of the users' input towards the performance operations management system 10. The features include the following. A search query system 56 allows a user to search for members of the supply chain and generates leads of companies applicable to the search criteria with the opportunity to appear at the top through sponsorships for increasing market share of current reach and beyond. That is, members may pay to be listed first in the search results. Since it is online, the profile picture personalizes the engagement of the supply chain by putting a picture with the party's name and company along with position title since the interaction is online. A feed page 58 enables to update the relevant and prospective customer base of innovative product features and services for the early-stage adopters-the users on the platform, along with tangible demonstration via pictures, videos, and explanations. Organizations are able to impersonally market or share information to their connections through the company's page, or more personalize the approach through a company representative via the user's own page. For more personalized and/or confidential marketing and communications approach internally or externally, a Private Messaging System allows you to communicate, share information or videos with a selected party or parties, privately. Information can be saved on the system 10 and is segmented amongst Manufacturer, Wholesaler, Third-Party sub-categories, as discussed in more detail below, under the “Save” tab in alphabetical order based upon company names. Multiple saved sources from a company will then be ordered by dates and publishers' last and first names. Each publication onto the system 10 encompasses the publishers profile picture with his/her name, position, and the company's name along with the text, video/picture material for validation of the publication source.

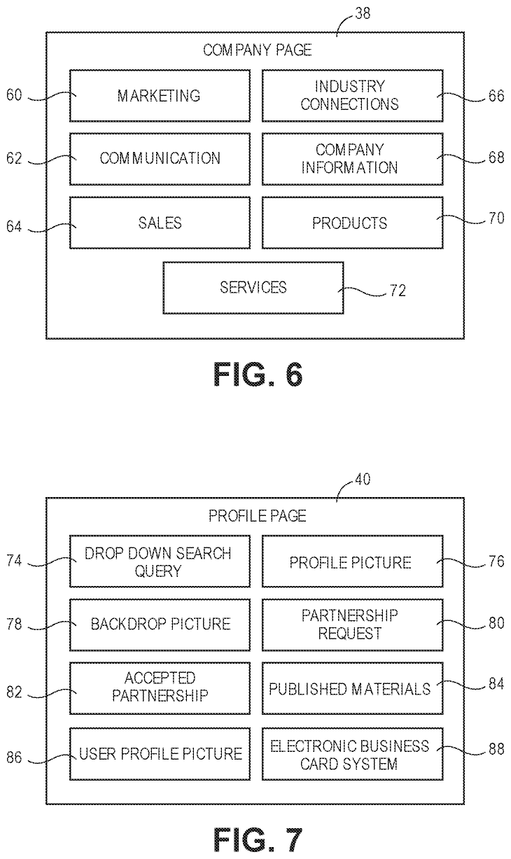

The company page 38, as shown in FIG. 6, includes information about each member of the supply chain. The company page 38 provides general or impersonal marketing 60, general communication 62, general sales 64, and general industry connections 66 of products/services, and includes company information 68, products 70 and services 72. Each company, or member, generally or impersonally markets products and services as the company itself. The company page 38 displays employees on the system 10 to connect along with company information, and the organizational hierarchy of key management. The company page 38 includes published materials as company: displayed on the home page 36 under Company Name, and capability to also post on company's page as Company, posting on other pages as Company. Each posted publication has interactive options such as “Like”, “Feedback”, “Share”, “Save”, etc. for further meeting the needs of the customers through the supply chain-increasing sales and eliminating waste through unnecessary production of one product line and increasing another by direct integration of the distribution channels. The same features expressed under an individual user's page applies to the company pages but for the company, generally, itself. The company's macroeconomics of the overall operations of each integral part within the company will be calculated for analyzing the company's overall health and identifying problematic issues for improving efficiency and effectiveness in the operations. The company page further includes a company biography, a listing of employees on the system 10, and an organizational hierarchy of management personnel.

The profile page 40, as shown in FIG. 7, provides personalized marketing, communication, sales, and industry connections of products/services via personnel users' pages. The profile page 40 includes a drop down search query tab 74 at the top of page with segmentation features, a profile picture 76 with the ability to upload a professional picture to display on the profile page 40, as well as the home page 36, a backdrop picture 78 with the ability to upload a picture that appears behind the profile picture 76, a partnership request icon 80 of one hand reaching out to shake hands with a “Partner” that allows one member to request a partnership with another member to segment the home feed page, and an accepted partnership icon 82 of two hands shaking that says “Partners” when first notified, after viewing notification it will express “Partnership” and the icon of two hands shaking. When viewing a page of a connected partner, the page shows two hands shaking and says “Partners”. The profile page 40 may include, or allow users to upload, published materials 84 which are displayed on the home page 36, the user's profile page 40, and capability to also post on the company page 38 as an individual representative. Each posted publication has interactive options such as “Like”, “Feedback”, “Share”, “Save”, etc. The profile page 40 also includes the following data associated with a user's profile picture 86: the user's name (with link), the user's position and title, a company name with a link to the company page 38, an address (user's address location if different from corporate), a telephone number and/or Fax number, and an email address via the system 10 which then sends a notification to the user's company email address, which may include the user's first name, that when activated, sends a message to a private messaging system.

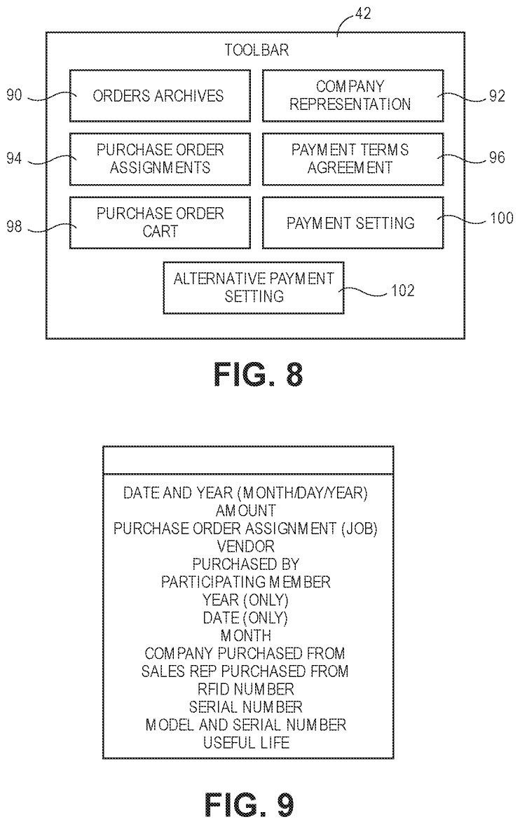

The profile page 40, as shown in FIG. 8, further includes an electronic business card system 88, wherein the user can upload a business card into their profile. In the system 10, users will be able to download business cards which will be saved and organized on the business card system 88 to efficiently find “Partners” for frequent communication and transactions. It will be organized as manufacturer, wholesaler, or third-party sub-categories for the supply-chain. This segment of the system 10 website 24 will have a search tab among the card filing system to find saved business cards. The electronic cards will be alphabetically organized by company names and then the last names of the representatives when there are multiple saved cards of representatives of the same company.

The toolbar 42 includes a plurality of interactive components, such as software buttons or highlighted words, which, when pressed or clicked, offer additional information or perform one or more functions. The toolbar 42 includes a component labeled “Order Archives” 90, which provides an order history on the platform of supplies and materials, segmented by months, years, and even projects along with total cost of goods sold which further total cost management features of projects can be activated upon the selected subscription model.

The toolbar 42 includes a component labeled “Company Representation” 92, that includes a first subcomponent labeled “Company as Company”, which provides a representative's capability to post material as Company. This option requires authorization by management. The component labeled “Company Representation” includes a second subcomponent labeled “Company as Representative”, which provides a representative to represent the company as an employee representative.

The toolbar 42 includes a component labeled “Purchase Order Assignments” 94, that provides data regarding purchase orders segmented by month, year, and capability of projects with its total costs, the overall month's and year's cost of goods sold (or revenue for suppliers). The component also provides the ability to review individual purchase orders' details the ability to purchase from multiple sources on same purchase order. The user may be able to view data from a current purchase order that is less than or equal to 30 days or from a purchase ledger that is greater than or equal to 31 days.

The toolbar 42 includes a component labeled “Payment Terms Agreement” 96, which provides an option to order and receive materials for project with electronically signed promissory note that must be paid within 30 days. The component also provides a consent to file a mechanic's lien against the project if there is a failure to pay.

The toolbar 42 includes a component labeled “Purchase Order Cart” 98, which provides the materials of the current order that is being placed. The number incorporated into the cart represents the number of line items in cart, not the total quantity of items in cart.

The toolbar 42 includes a component labeled “Payment Setting” 100, which provides a default payment source required to be on record for transactions. Each user must have one on file to establish accounts and profiles on platform. The Payment Setting source is the default method that is a stationary requirement for the system.

The toolbar 42 includes a component labeled “Alternative Payment Setting” 102, which stores secondary payment sources for diversifying the utilization of cards for payments or use electronic check.

The system 10 provides management of new equipment and materials purchase to track and control the expenditures spent on items, servicing information on equipment to maximize the efficiency and effectiveness throughout the useful life of items to maximize the return of investment and being able to make better informed decisions on whether to invest money on trying to maintain a system or purchase a new item. The system 10 develops statistical data on maximizing the performance operations management from the time of purchase of the new equipment (or used) from the progressive supply chain (or reverse-supply chain), marketing and promoting companies for servicing and maintaining items, such as air conditioners which includes strategic product/service placement offerings to reach key target markets and decision-makers. The system 10 transmits data to a user's web browser that displays a map of the United States and then a globe of the world with each country as the system scales so the user can segment the business intelligence data for comparative analysis by selecting a state or region using the system map of the United States. As the concept scales internationally, the user will be able to select the following on the globe of the world: 1. State or Providence, 2. Region (which also applies to the initial launch within the U.S.), 3. Country (as it scales to integrate and reach companies beyond the United States). The user will be able to gain insight of the given industry on the local, national, and international range. The researcher will be able to further segment platform data for relevant and reliable information by selecting companies that are: A. Small, B. Medium, C. Large.

The segmentation criteria can be divisible and convertible information by the revenue range (size based upon revenue) or based upon the number of employees return-on-investment (ROI) per employee analysis. This provides different ways of viewing and analyzing a company's position in an industry as well as determining how efficient and effective the company is operating for maximizing the return on investment for the capital input. The users will be able to perform industry research based upon local, national, and international basis. The business intelligence information will be expressed in writing and visualization tools using the bell curve, tables, graphs, charts, whisker plot, etc. The tools will incorporate the individual company's position and information and the general statistical data of the industry with the capability to segment based upon the above criteria. On the tools such as the bell curve, whisker plot and graphs, the information will overlay each other for analyzing if there is sub-par performance, at equilibrium, or above industry average; this pinpoints the company's position in comparison to the industry range of the competitors along with relevant and reliable comparison capability of privately-held companies. The user will be able to insert a screen split to keep their own company's information stationary as he/she scrolls through the general statistical data for analysis. The system will integrate charts, tables, and applicable images, tools for effective expression of information.

The system 10 provides asset resale management wherein the website 24 provides a platform for when an item that has been in a member's possession for a threshold period of time or that has reached the end of its useful life, for example a truck that is five years old and 100,000 miles along with the industry-specific equipment on it (i.e. mounted toolboxes on a truck), could be automatically marketed for sale directly to the relevant target audience. The data can be reviewed using the full screen view for exclusively analyzing company or industry information. The split-screen feature is for comparative analysis of company and industry performance for benchmarking relevant and reliable information sources for improving strategic decision-making processes.

The tag readers 12 allow members to physically manage physical assets and maintain quantity control internally. The system 10 sets bounds of when to use inventory with the ability to code to project for linking to jobs, transactions, and suppliers to meet key performance metrics. The system 10 can determine a period of time for when unused inventory or stock materials automatically transition from inventory to listed for sale, such as 30 days, 60 days, 90 days, and so forth. Non-used materials (private) that exceed parameters automatically transfer to be listed for sale (Public) on platform. The standard default setting will be ‘None’ which requires the user to select the time parameter for the conversion cycle time. The system 10 provides real-time management of raw materials to projects/customers. The system 10 develops company ratios of inventory management—Private Internal Use (Microeconomics). The system 10 develops segmented macro industry data formulated and segmented from the microeconomics of the relevant and reliable privately-held companies. The system 10 has the ability to research ratio segmentation data according to construction segments (plumbing, heating and air, framing, or suppliers/distributors, engineers, architects and so forth)—the wholistic supply chain from the planning, execution to liquidity of leftover supplies and materials. Users can research the segmented ratios of the small medium, large company for business intelligence analysis for sufficient strategic product/service positioning and performance metrics.

The system 10 develops industry ratios with the ability to segment data of micro to relevant and reliable Macro Economics. The system 10 provides the ability to research ratios of industry segmented by company sizes, location, revenues. When inventory exceeds predetermined parameters, it will become searchable—connecting buyers and sellers while not listed for sale, which helps meet ratios. The feature overall can be turned ‘On’ to be searchable after prerequisite time period or ‘Off’ to deactivate the feature. The individual items can be deactivated from the search query for items the party plans to keep. The inventory search results will display the confidential ‘In Network Partners’ first and then the confidential external sources. The user selects one or both which receive the notification. The other party can ‘Accept’ to reveal their identity to connect but still not partners and begin exchanging information and negotiating via the private messaging system. Registered inventory via the system 10 can be searched by company personnel and review what went where and costs associated with the items, projects, total costs, performance, efficiency, etc. The default setting of the registered inventory is ‘None’ until the user selects the allocated time parameter for this feature.

Companies determine desired ratios/financials. The system 10 helps direct businesses on how to meet desired performance with business intelligence. The system 10 platform provides recommendations and develops insight on improving ratios on inventory to help meet goals such as purchasing reoccurring materials from Source A oppose to B generating a savings of and increasing the company performance in revenue and percentage terms along with the overall efficiency improvement with the adoption of the strategic recommendation or liquidation of registered item in stock. The system 10 tracks each item of inventory to each project, costs, orders via platform for better internal controls and profitability.

The system 10 generates general, segmented industry ratios for analyzing operations of relevant and reliable benchmarking and individual company ratios for comparative analysis. The system 10 provides financial performance calculations, wherein the system 10 takes the inputted variables and calculates company performance data. For the missing required information, i.e. income, the system will have a box for the user to insert required information to calculate results.

The system 10 provides computations and calculations related to the business and financial aspects of the members of the supply chain, segmented ratios of macro privately held companies for data comparison and analysis, and strategic marketing recommendations for improving financial performance. For example, the system 10 calculates the following activity ratios, wherein some of the input data is automatically provided from purchase and other financial data supplied by the members. Additionally, each activity ratio may be calculated for each member or a plurality of members' contribution margin but is not limited to the following equations.

Inventory Turnover=(Cost of Goods Sold)/(Average Inventory) EQ. 1

Receivable Turnover=(Net Revenue)/(Average Receivables) EQ. 2

Payables Turnover=Purchases/(Average Payables) EQ. 3

Asset Turnover=(Net Revenue)/(Average Total Assets) EQ. 4

The system 10 calculates the following liquidity ratios, wherein some of the input data is automatically provided from purchase and other financial data supplied by the members. Additionally, each liquidity ratio may be calculated for each member or a plurality of members' contribution margin but is not limited to the following equations.

Current Ratio=(Current Assets)/(Current Liabilities) EQ. 5

Quick Ratio=(Cash+(Short Term Marketable Securities)+(Accounts Receivable))/(Current Liabilities) EQ. 6

Cash Ratio=(Cash+(Short Term Marketable Securities))/(Current Liabilities) EQ. 7

The system 10 calculates the following solvency ratios, wherein some of the input data is automatically provided from purchase and other financial data supplied by the members. Additionally, each solvency ratio may be calculated for each member or a plurality of members' contribution margin but is not limited to the following equations.

Debt-to-Asset=(Total Liabilities)/(Total Assets) EQ. 8

Debt-to-Capital=(Total Debt)/((Total Debt)+(Total Shareholder Equity)) EQ. 9

Debt-to-Equity=(Total Debt)/(Total Shareholder Equity) EQ. 10

Interest Coverage=(Earnings Before Interest and Taxes)/(Interest Payments) EQ. 11

The system 10 calculates the following profitability ratios, wherein some of the input data is automatically provided from purchase and other financial data supplied by the members. Additionally, each profitability ratio may be calculated for each member or a plurality of members' contribution margin but is not limited to the following equations.

Gross Profit Margin=(Gross Income)/(Net Revenue) EQ. 12

Operating Profit Margin=(Operating Income)/(Net Revenue) EQ. 13

Net Profit Margin=(Net Income)/(Net Revenue) EQ. 14

Return on Asset=(Net Income)/(Total Assets) EQ. 15

Return on Equity=(Net Income)/(Total Shareholder Equity) EQ. 16

Purchases=(Cost of Goods Sold)+(End Inventory)−(Beginning Inventory) EQ. 17

Total Debt=(Notes Payable)+(Current Debt)+(Long Term Debt) EQ. 18

Earnings Before Interest and Taxes=(Net Income)+(Income Taxes)+(Interest Expenditures) EQ. 19

The system 10 determines how much money has been spent maintaining a specific item, the times it has been serviced, and what has been wrong with the item further providing insight for better decision making on maintaining or replacing items. The system 10 develops a portfolio of data for each unit, streamlining the process through automation by establishing future service dates or when to contact a customer on when an item needs to be serviced via the management database. The system 10 determines personalized micro statistical data of the useful life of specific items internally (for a particular member, such as the owner, to view) and comparing it to, or benchmarking it against, general macro statistical data. (This provides internal controls of the systems along with realistic information instead of completely relying on manufacturers, distributors, contractor's information which could be flawed or incomplete information-provides realistic, not theoretical input.)

The system 10 receives specific details of a given item, such as the purchase amount of item, the amount of money invested in maintaining it, the projected useful life internally along with the manufacturer's period of time for a projected life. The system 10 may schedule or establish service dates for maintaining optimal operations, provide notices for maintenance, and assign a service task to a specific person who then signs off on when the task is performed and maintaining efficiency controls in a decentralized location operation (DLO). It is a turnkey management system 10 on the service side which would be very useful in a decentralized location operation. This tracks and controls the operational cash flow's expenditures and produces graphical information (tables, charts, and so forth as already expressed) for better business intelligence information which the graphical information would also apply to the progressive supply chain purchase data information as well as the system management side as well—providing visualization aide of the data to make tangible the information for making sense to the users and being able to make better decisions.

The system 10 also provides real estate management wherein the system 10 maintains systems/items in rental units, contractors servicing items on a larger scale for customers (air conditioners, heaters, and so forth), suppliers services for clients, promoting after the sale products and features to build upon for service after the sale of products, etc.

The system 10 provides video conferencing for members or users and paging of individual users either through the website 24 or other applications. The server 14 communicates with the electronic devices 18 of individuals participating in the video conference to provide video and audio signals of the conference to allow the individuals to have a virtual meeting. During a video conference, a window may appear in each participating user's web browser or other application that includes a person's name, title, and company name (for when there are representatives from multiple companies) of the people included into the meeting and the ability to display who is currently logged in. The system 10 sends a notification to the user via the computer and/or smartphone to join if an individual forgets to login to the system conference meeting or to actively seek somebody to join unexpectant for a rapid response or request additional input in a subject matter from additional party(s), or if participants unexpectedly need assistance. The user can search its “Partners” and add specific members to join prior or during the online meeting. The invited party can “Accept” or “Decline” the invitation to join along with the option to insert a brief message which will be sent back to the meeting initiator along with the other parties who “Accepted” or “Accept” the invite. The application will include text insert table for parties to be able to type information, attach and share documents online in the meeting from a personal computer or published on the database. There will be live streams of the individuals involved in the meeting so you can see and interact with all of the members involved in real-time. The live conference application will include the feature to access other aspects of the platform in a minimized window (seeing and interacting with the parties involved while simultaneously accessing other aspects of entire system, i.e. current internal inventory, statistical data, to name a few examples) or maximizing the window to research and find information or sources (people, charts) and then minimize it back to the normal setting.

The system 10 also connects, or interfaces, with Universities and Trade Schools. The system 10 provides marketing and promoting construction programs to or via universities and trade schools. This includes the program information, the administrators, current students and listing available industry jobs-connecting the formal training institutions, current students to industry, industry to prospective establishments for furthering industry training and education, and upon the education completion finding jobs. The industry's work-force is contracting due to the stagnation of innovation of technology to attract Millennials as the Baby Boomers retire. The system 10 also connects Universities, Trade Schools, and School Districts to the supply chain to become more efficient and effective in operations purchasing materials, managing inventory and cost drivers in the progressive and reverse-supply chain management system—lean operations. The system 10 further connects Insurance Companies for business needs and Agents Servicing the Industry in order to integrate business insurance companies and agents that specialize in the business sectors for meeting the needs of the industries along the supply chain.

The system 10 also provides in-feed data segmentation. A plurality of data segmentation tools include “Search” (to find specific items) “Find and Edit” (find item lost in the system 10 and change to the correct project), and “Returns” (the items purchased and returned or orders that are placed and then cancelled). A list of options for data segmentation shown in FIG. 9 apply to the purchasing new or used items via the system, performance operations management for maintaining the widgets, “Liquidation” for the items that are sold at the end of the useful life, and “Returns” for items purchased and units sold that are taken back. The “Participating Member” option applies when the Work-Order in Progress consists of multiple people but not sure who originated and submitted the purchase order.

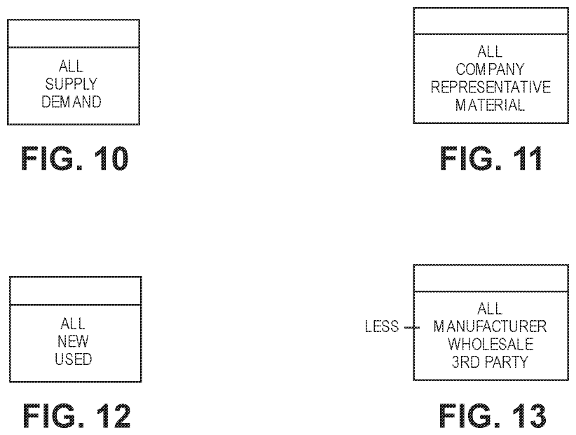

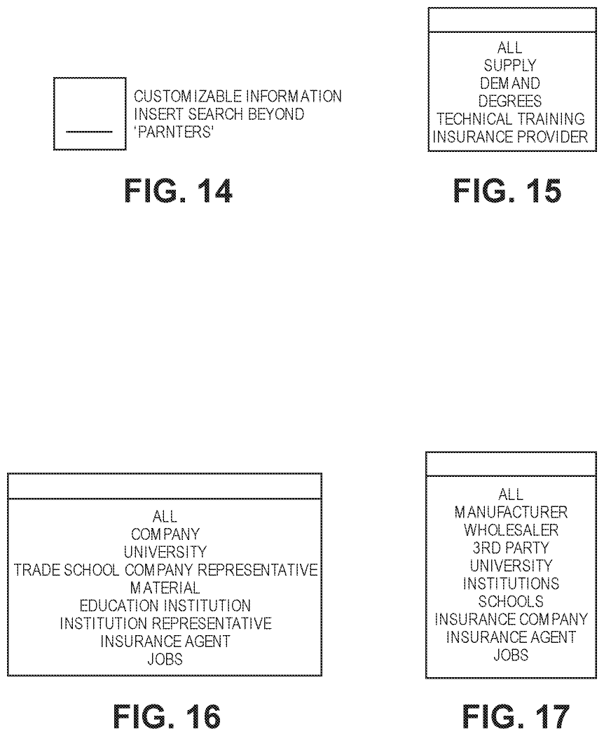

The following figures illustrate a plurality of lists of options that are also available to the user for data segmentation. Each list may appear, as a pop-up window, pull-down menu, or the like, on the website 24, which is shown on a screen or display of the electronic device 18 of a user trying to retrieve data or information about the supply chain or one or more of its members. In some embodiments, each list may appear as a group of letters in a box. The user may click or tap on the appropriate word or letter to see the results of the data segmentation. FIG. 10 illustrates options of segmenting home feed of “Partners” (Companies; Suppliers, Contractors & Representatives) within the Supply Chain. FIG. 11 illustrates options of segmentation of whether looking for Company, individual Representative(s), and/or material(s). FIG. 12 illustrates options of segmentation of Available Materials Currently Listed. FIG. 13 illustrates options of a Progressive Supply Chain Search with a segmented search of “Partners” shows Companies, Individuals of relevant products/services within the network followed by relevant external sources for additional prospective connections and channels. Promoted Companies, Representatives featured at the top which may include in-network or out-of-network connections. Other relevant parties and materials will be displayed following promotion/connections for further “Partnerships”. FIG. 13 also illustrates options of a Reverse-Supply Chain Search Notification with searching party publishes notification of need within segmentation of “Partners” to find materials not currently listed for sale but other party has and meets need of the searching party. FIG. 14 illustrates a box for the advanced Reverse-Supply Chain Search reaches relevant audiences beyond the current “Partners”—a “Sponsored Advertisement” in which the user inserts a search string. Segments feed in real-time when subcategories are selected. The Reverse-Supply Chain Search Queries can be managed by accessing the “Search Queries” tab which stores the search and remains active until deactivated.

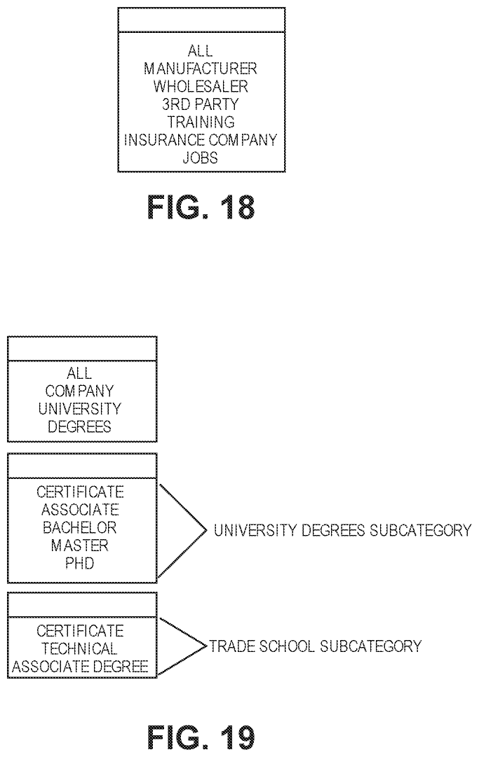

The system 10 also provides in-feed data segmentation related to educational institutions and insurance providers, as illustrated in FIGS. 15-18. Data segmentation for educational institutions with a university degrees subcategory and a trade school subcategory is shown in FIG. 19. The search query applies to the segmentation tool on the home page as well as the “Saved Information” tab: Manufacturer, Wholesaler, 3rd Party, Education Institution (University, Vocational Technology), Insurance, Jobs. The additional features will entail the same attributes as the previous segmentation in the way it pertains to their aspect. For the students and independent or unemployed industry workers, they can purchase individual access to the system to use the industry information, connections via “Partners,” and search for jobs and stay up-to-date on the industry trends and projections. The company attributes that apply to individual representatives and companies will not apply such as the inventory management system and assigning materials to projects along with the cost driver management, tracking and controls.

The system 10 provides the ability for users to view inventory of one or more members. By using a web browser or other database viewing program or application, a user may view inventory or segment inventory data. A button or other indicia for searching or segmenting inventory data may appear on the home page 36 or other page of the website 24. The user can click the button or indicia to request inventory data. When a request to view inventory or segment inventory data is received, the system 10 presents inventory data under the following in stock company inventory column headings: ID#, Inventory Item, Project Assignment, Purchase Date, Project Assignment Date, Purchased By, Assigned By, Days Sales Outstanding (DSO), Efficiency Calculation, Projected DSO, and so forth. The system 10 also allows users to search for inventory items and may offer the following search options or parameters: a searchable period, searchable when greater than 14 days, searchable when greater than 30 days, or a customizable search period. Inventory items may be searchable immediately or may not be searchable, and may convert listing or “None” which is the default setting. The system 10 may also present inventory data for in-stock listings under the following column headings: ID#, Inventory Item, Purchase Date, Purchased By, Assigned By, DSO, Efficiency, Sale Date, Sold By, and so forth. The system 10 may further provide a check box adjacent the column headings that, when checked, eliminates “In-Stock Listing” and moves back to “In-Stock”. Users must select “Projected Days Sales Outstanding” for the conversion back to “In-Stock”, selecting “None” will keep the item in “In-Stock”. Some of the column headings are subcategories with the exception of “In-Stock Listings”.

The system 10 may have the following additional features. The system 10 provides a personalized sales, marketing, and communications platform to increase efficiency and effectiveness along with streamlining updates, to each user's business email address used for logging into the system 10, servicing a supply chain of diminishing margins of increased competitive industry. The system 10 provides a Software as a Service (SaaS) Subscription Model. The system 10 provides direct, strategic marketing and sales via targeting appropriate decision makers. The system 10 streamlines the sales process via the entire supply chain online, i.e. manufacturers, wholesalers, contractors for progressive supply-chain and reverse supply chain. The system 10 increases the sales capacity in the supply chain from a 1-to-1 in person sales at brick and mortar locations to the online system to increase efficiency and reach beyond the local markets and boundaries, both customer reach and financial performance metrics. The system 10 eliminates waste of having to repetitively answer mundane questions and reduces the overhead cost drivers of the per store unit and associated cost streams. The system 10 has an ability to conduct market research on the current available products and services on a single platform. Using the system 10, suppliers can reach new customer bases in new markets with the personalized sales and communications. The system 10 has an ability to connect and follow, or “Partner,” with companies of interest that are viable to a given company. The system 10 has an ability to save findings on the system 10 to review and compare to other options at a later time. The system 10 can transition from direct marketing via mailings and not being sure they reach the key decision-makers, the most expensive method, to the online system for strategically reaching precise personnel regarding the matter. The system 10 provides online strategic tracking and control of the direct materials ordered for commercial projects, along with the tracking the cost driver totals amongst each project. The system 10 provides a personalized online sales strategy and buying process with company profiles and company representative profiles. The system 10 provides a centralized platform to stay up-to-date on product and service offerings via the supply chain. The system 10 provides a technology platform which reduces overhead and also includes marketing and sales cost streams to increase profitability of the companies within the supply chain. The system 10 provides an increased selection of supply distributors, in return the capability to strategically target new customers in the supply chain distribution in new markets without all of the overhead of per store and corporate oversight.

Using the system 10, most productive sales personnel can become even more effective by eliminating the waste of traveling to meet with each customer along with all of the cost drivers associated with it, having to talk to them over the telephone for non-important matters resulting in less efficiency, and overall reducing the unnecessary overhead expenses that consume profits. In return, sale products/services at lower costs with increased profitability for the supplier and in return the contractor and associated sectors in the supply-chain while increasing the product/service offering to the end user.

The system 10 can monitor the reverse supply chain and has the ability to liquidate used materials to convert the direct materials to cash to increase profitability of the projects and the overall financial health of the company. As a result, the company can reinvest the capital into additional projects to increase revenue for the appropriate companies in the supply chain as well as its own total revenue.

The system 10 provides private or personalized marketing, sales and communication to key personnel via the website 24. The system 10 has an ability to upload pictures, text information which reduces cost production of tangible material and distribution overhead per mailing.

The system 10 provides a non-personalized sales strategy capability via the company page or general publications to personalized sales approach via company representatives and strategic targeting of other parties.

The system 10 has an ability to search and connect with companies and personnel to segment the stream on the home page to be personalized and relevant to each user then followed by non-“Partner” relevance.

The system 10 provides strategic marketing services for expanding networks, sales in the progressive supply chain, liquidating inventory assets or give notice of products/services party is looking for and meets the need of one party and liquidates the asset for the other an implementation of a cost reduction initiative. The system 10 provides strategic marketing placements via the platform to promote key connections, products/services and companies to ideal target markets.

The system 10 has an ability to query search results via the website which first starts by displaying promoted parties, “Partners”, and companies within the user's network followed by relevant parties and entities outside the user's network for further connections.

The system 10 provides wholistic supply chain distribution and communication from manufacturers, wholesalers, and contractors.

Using the system 10 to increase profits and cash on hand, the reverse-supply chain liquidates industry specific assets and improves the balance sheet for company performance.

The system 10 has an ability to be accessed from electronic devices 18 in the office and downloadable smart phone (electronic device 18) applications for in the field.

The system 10 has an ability to scan documents from field operations by taking picture of forms and coding information to projects to streamline private, company information from field operations to corporate in real-time.

The system 10 has an ability to connect capital sources (lending institutions, seed investors, venture capitalists, etc.) with businesses for scalability, mergers and acquisitions (nationally/internationally), and divestitures, outsource business processes, functions, strategic alliance and joint ventures.

The system 10 has an ability to incorporate business law attorneys, engineering firms, architects, surveyors, etc. onto the system 10 that are an integral source to the overall planning and execution of the construction process, in addition to the ongoing operations.

The system 10 has an ability to integrate social sharing links to share sources of information from websites.

Using the system 10, companies select a sub-category industry declaration which will appear on company profile pages for better strategic searches, connections, and serviceability amongst the supply-chain.

Using the video conferencing feature of the system 10, multiple parties can virtually meet at once via desktop device at the corporate office or smartphone for in the job field. Parties are able to share information finding via the website 24, attach new documents to share and upload at the meeting online.

The system 10 includes a work-flow visualization builder wherein multiple users are able to work online together to standardize processes by producing systematic procedures, review standardized operating procedures' charts along with are text input for explanation. The system 10 will have a collaboration tool, text or video, for employees to be able to collaborate while working together. Ability for comparative analysis of the average savings of time and money with the revised processes compared to the average time and money required to perform task. The feature will project the time savings (or loss) and how that will affect the client user's company's overall financial performance.

The system 10 provides online client consulting in combination with video conferencing, the work-flow visualization builder, and business intelligence through system data, the SaaS company will provide consulting engagements via the medium for professional services on improving operations and profitability for users or use the data meeting the client for in-person client consulting services.

The system 10 provides an automated graph builder in which the system 10 generates graphical data for industry segment as a whole, the sub-categorized segment pertaining to the individual user for benchmarking and comparative analysis and the individual user's company's performance. The system 10 will allow for companies to be able to reference different region's performance and graphical data, nationally and internationally. This feature will also work in conjunction with the work-flow visualization builder to create business intelligence insight economically and procedurally in the efficiency modification operations.

The system 10 further incorporates the suppliers of raw supplies and materials to the manufacturers to produce the products that are then distributed to the wholesalers and through the remainder of the supply chain. The system 10 integrates logistics companies for distributing and managing getting supplies, materials and products from Point A to Point B and so forth; this also entails the same attributes as the overall system configuration in regards to the companies, employees and the remainder of the components. In the logistical operations, the individual shipments can be tracked in real-time from the ordering point, the shipment process, and to the end user whether if it is raw materials or products for use, installation, liquidation and/or serviceability.

The system 10 interfaces with, and connects to, the aviation industry to couple the supplies and materials to manufacturers for manufacturing production, manufacturers connected to the wholesalers, wholesalers to retailers and the secondary resale market for the distribution of new or used planes. The same attributes apply to these sectors that have already been expressed via the product life-cycle from purchase to managing from the manufacturing process to the serviceability of planes, and then selling the items as described in previous communications which also includes companies such as title companies for transfer of ownership.

Using the system 10, companies and personnel can request, submit, and review bids of products and/or services of projects or items. The projected budgets can be compared and managed in real-time to the actual costs along with the variance as well as statistical data/graphs for visualization. For the proposals, companies can review, “Accept” or “Reject” the proposed offering electronically and the documents will be stored on the system—streamlining the entire process. The accepted proposals will then transfer to the “Contracts” section in which will require the parties to electronically sign the document; the rejected proposals will be moved to the “Declined Proposals.” The current offerings will be in the “Pending Proposals” section. There will be search tabs to assist in finding specific documents in a timely manner.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A supply chain inventory management and information sharing system comprising:
a plurality of tag readers configured to read tags of inventory items of members of a supply chain; and
a computer server including a processing element in electronic communication with a memory element, the processing element configured or programmed to perform the following:
receiving data from the tag readers regarding items of inventory,
receiving data regarding an organizational profile of each member of the supply chain,
receiving financial data from each member of the supply chain,
hosting a website that provides access to inventory data, organizational data, and financial data,
segmenting data to allow users to view selected portions of the inventory data, and organizational data, and
utilizing the financial data to calculate selected activity ratios, liquidity ratios, solvency ratios, or profitability ratios.

2. The system of claim 1, wherein the website includes a login page configured to accept data from the user used to provide access to the website, a home page including features to which every user has access, a company page including information about each member of the supply chain, a profile page including personalized marketing, communication, sales, and industry connections of products and services, a toolbar including a plurality of interactive components, which, when activated, offer additional information or perform one or more functions.

3. The system of claim 2, wherein the home page includes a search query system that allows users to search for members of the supply chain, wherein members pay to be listed first in the search results.

4. The system of claim 2, wherein the company page includes company biography, general product information, sales information, service information, marketing information, and displays external industry connections, employees on system, the products and services, and organizational hierarchy of management personnel.

5. The system of claim 2, wherein the profile page includes a partnership request icon that allows one member to request a partnership with another member to segment the home feed page.

6. The system of claim 2, wherein the profile page includes an electronic business card system, wherein the user can upload a business card into his profile.

7. The system of claim 1, wherein the processing element is further configured or programmed to provide video conferencing service that allows individuals of members of the supply chain to have a virtual meeting.

8. The system of claim 7, wherein the processing element is further configured or programmed to send a notification to an individual who was scheduled to attend the virtual meeting but did not and request additional input in a subject matter from additional parties.

9. The system of claim 1, wherein the processing element is further configured or programmed to provide asset resale management such that an item that has been in a member's possession for a threshold period of time is marketed for sale on the website.

10. The system of claim 1, wherein the processing element is further configured or programmed to determine a period of time for when unused inventory or stock materials are listed for sale.

11. The system of claim 1, wherein activity ratios calculated by the processing element include inventory turnover, receivable turnover, payables turnover, and asset turnover.

12. The system of claim 1, wherein liquidity ratios calculated by the processing element include current ratio, quick ratio, and cash ratio.

13. The system of claim 1, wherein solvency ratios calculated by the processing element include debt-to-asset, debt-to-capital, debt-to-equity, and interest coverage.

14. The system of claim 1, wherein profitability ratios calculated by the processing element include gross profit margin, operating profit margin, net profit margin, return on asset, return on equity, purchases, total debt, and earnings before interest and taxes.

15. The system of claim 1, wherein the processing element is further configured or programmed to determine personalized micro statistical data of life of specific items internally and comparing it to general macro statistical data.

16. The system of claim 1, wherein the processing element is further configured or programmed to receive a time period of a projected life of an item, schedule service dates, provide notices for maintenance, and assign a service task to a specific person.

17. The system of claim 1, wherein the processing element is further configured or programmed to receive data regarding a plurality of construction projects.

18. The system of claim 1, wherein the processing element is further configured or programmed to market and promote construction programs, universities and trade schools.

19. A supply chain inventory management and information sharing system comprising:
a plurality of tag readers configured to read tags of inventory items of members of a supply chain; and
a computer server including a processing element in electronic communication with a memory element, the processing element configured or programmed to perform the following:
receiving data from the tag readers regarding items of inventory,
receiving data regarding an organizational profile of each member of the supply chain,
receiving financial data from each member of the supply chain,
receiving data regarding a plurality of construction projects,
hosting a website that provides access to inventory data, organizational data formulating the company's overall health ranging from the efficient use of capital, capital assets, supply and reverse supply chain resources, and financial data, the website including a login page configured to accept data from the user used to provide access to the website, a home page including features to which every user has access to their own data contribution performance which then is factored towards the company's overall health by compiling all of the users' input towards the performance operations management system, a company page including information about each member of the supply chain, a profile page including personalized marketing, communication, sales, and industry connections of products and services, a toolbar including a plurality of interactive components, which, when activated, offer additional information or perform one or more functions,
providing video conferencing service that allows individuals of members of the supply chain to have a virtual meeting,
sending a notification to an individual who was scheduled to attend the virtual meeting but did not or to an individual who can provide additional assistance,
providing asset resale management such that an item that has been in a member's possession for a threshold period of time is marketed for sale on the website,
determining a period of time for when unused inventory or stock materials are listed for sale,
segmenting data to allow users to view selected portions of the inventory data, and organizational data, and
utilizing the financial data to calculate selected activity ratios, liquidity ratios, solvency ratios, or profitability ratios.

20. A supply chain inventory management and information sharing system comprising:
a plurality of tag readers configured to read tags of inventory items of members of a supply chain; and
a computer server including a processing element in electronic communication with a memory element, the processing element configured or programmed to perform the following:
receiving data from the tag readers regarding items of inventory,
receiving data regarding an organizational profile of each member of the supply chain,
receiving financial data from each member of the supply chain,
receiving data regarding a plurality of construction projects,
hosting a website that provides access to inventory data, organizational data, and financial data, the website including a login page configured to accept data from the user used to provide access to the website, a home page including features to which every user has access, a company page including information about each member of the supply chain, a profile page including personalized marketing, communication, sales, and industry connections of products and services, a toolbar including a plurality of interactive components, which, when activated, offer additional information or perform one or more functions,
providing video conferencing service that allows individuals of members of the supply chain to have a virtual meeting,
sending a notification to an individual who was scheduled to attend the virtual meeting but did not,
providing asset resale management such that an item that has been in a member's possession for a threshold period of time is marketed for sale on the website,
determining a period of time for when unused inventory or stock materials are listed for sale,
segmenting data to allow users to view selected portions of the inventory data, and organizational data, and
utilizing the financial data to calculate selected activity ratios, liquidity ratios, solvency ratios, or profitability ratios, wherein
the activity ratios include inventory turnover, receivable turnover, payables turnover, and asset turnover,
the liquidity ratios include current ratio, quick ratio, and cash ratio,
the solvency ratios include debt-to-asset, debt-to-capital, debt-to-equity, and interest coverage, and
the profitability ratios include gross profit margin, operating profit margin, net profit margin, return on asset, return on equity, purchases, total debt, and earnings before interest and taxes.
